(19) United States
(12) Patent Application Publication
(10) Pub. No.: US 2008/0010293 A1
(43) Pub. Date: Jan. 10, 2008

(54) Service level agreement tracking system

(76) Inventors: Christopher Zpevak, St. Louis, MO (US); Gregory Hardey, St. Louis, MO (US); Mae Ward, Defiance, MO (US); Vicki Wolff, Fenton, MO (US)

Correspondence Address: BRINKS HOFER GILSON & LIONE, P.O. BOX 10395, CHICAGO, IL, 60610, US

(21) Appl. No.: 11/484,022

(22) Filed: Jul. 10, 2006

(51) Int. Cl. G06F 17/30

(52) U.S. Cl. 707/10

(57) ABSTRACT

A Service Level Agreement Management System provides a web-based system for managing Service Level Agreements (SLA's) with suppliers. Legal contracts, between a customer and a supplier to provide services, usually contain SLA's that define acceptable performance in the delivery of the services. With respect to SLA's, the SLA management system is used by suppliers to record SLA encounters, used by customers to measure supplier performance, and used by both parties to facilitate resolution to SLA disputes. The SLA management system is able to compare SLA performance across different contracts, projects, and different suppliers.

### BACKGROUND

1. Technical Field

The disclosure relates to systems for monitoring service level agreements for contracts. In particular, the disclosure relates to a system that allows automated or manual input of service level agreement terms, tracking of service level agreement results, and resolution of disputed service level agreement encounters.

2. Background Information

Including Service Level Agreements (SLA's) in contracts and holding suppliers accountable to them is a common practice. The performance of suppliers against SLA's is most commonly recorded and tracked in spreadsheets or word processing documents. A centralized web-based tool designed to manage SLA performance at both an individual contract level and a program (collection of contracts and suppliers) may allow streamlined communication flows and provide powerful reports in a manner that requires minimal effort. Achieving these same results with spreadsheets is a very time-intensive process. Therefore, a need exists for an SLA tracking system that allows comprehensive monitoring and evaluation of SLA performance.

### BRIEF DESCRIPTION OF THE DRAWINGS

The disclosure can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates an example service level agreement tracking system.

FIG. 2 illustrates an example supplier interface system.

FIG. 3 is a flow diagram of an example process that accepts service level agreement data.

FIG. 4 is a flow diagram of example acts to initialize a service level agreement tracking system.

FIG. 5 is a flow diagram of an example process that tracks service level agreement encounters.

FIG. 6 is a flow diagram of an example dispute resolution process in a service level agreement tracking method.

FIG. 7 illustrates a computer system.

### DETAILED DESCRIPTION

A Service Level Agreement Tracking Engine (SLATE) system provides a web-based application for managing SLA's with suppliers. Legal contracts, between a customer and a supplier to provide services, usually contain SLA's that define acceptable performance in the delivery of the services. With respect to SLA's, the tracking system disclosed herein may be used by suppliers to record SLA encounters, where an SLA encounter is any time the supplier performs an action for which an SLA has been defined; used by customers to measure supplier performance; and used by both parties to facilitate resolution of SLA disputes. The tracking system is able to compare SLA performance across different contracts, projects, and different suppliers. The SLATE system may be used to track and report on non-contractual performance measures. The functionality is the same as if it were an SLA, the only difference is that the performance is not contractually guaranteed by the supplier.

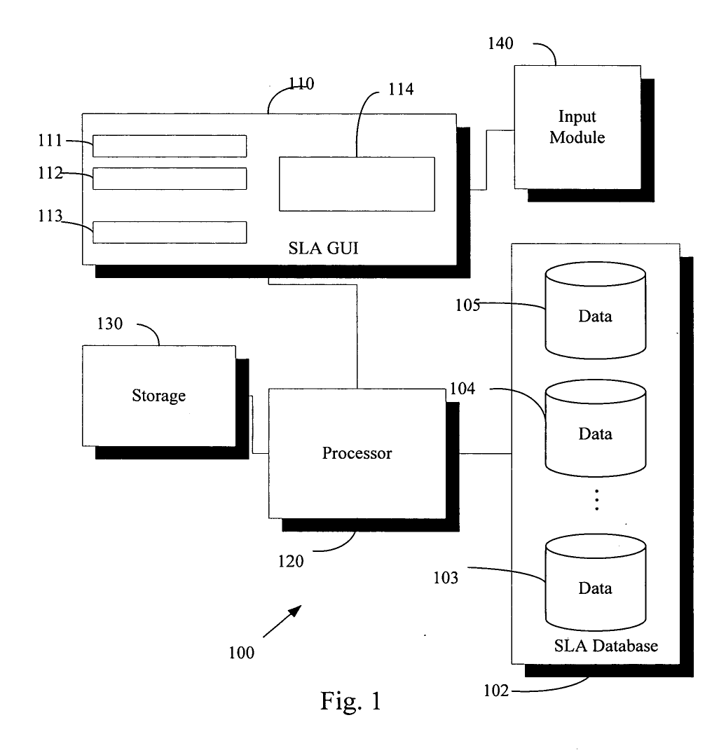

FIG. 1 illustrates an SLA management and tracking system 100. The system 100 includes a database configured to store records related to SLA terms and parameters, such as an SLA database 102, a graphical user interface (GUI) adapted to receive and display SLA data, such as an SLA GUI 110, a processor 120, a storage 130, and an input module 140.

The SLA database 102 includes one or more database modules 103, 104, and 105. The database modules 103, 104, and 105 are configured to store data records related to SLA terms and parameters, such as an SLA trigger associated with the SLA term, an SLA desired outcome parameter, and an SLA comparator parameter. The SLA desired outcome parameter includes a determined level, number, or quality of the SLA term desired, such as defects per million, number of code lines, response time, or other desired outcome parameters. The SLA comparator operator includes comparators such as greater than, less than, greater than or equal to, less than or equal to, equal to, and not equal to operators.

Examples of SLA terms and parameters include, but are not limited to, terms such as quality of service, response to down-time issues, lines of code provided for a certain period, response to customer complaints, periodic quality checks, event driven response parameters, on-time-delivery parameters, an SLA reporting frequency, (where it is possible to send automatic reminders (such as by email) to the supplier to enter their SLA results for that period) and other parameters related to SLA's defined in a contract. An SLA term may also have a liquidated damages amount associated with the SLA term. Liquidated damages detail the financial incentive for the supplier to meet SLA obligations. They are detailed in the statement of work. The liquidated damages amount may specify a money damages that is determined to make the client business entity whole due to missing an SLA term at an SLA encounter.

The SLA database 102 may comprise a structured query language (SQL) database. The SLA database 102 is stored in a computer-readable medium such as a volatile or non-volatile memory device. Examples of memory devices include flash memory, dynamic random access memory (DRAM), static random access memory (SRAM), electronically eraseable programmable read only memory (EEPROM), floppy disks, compact disc (CD), digital versatile disc (DVD), hard drive, Syquest, or Jazz drive. The SLA database 102 may be stored in multiple memory locations, or may be stored in one memory location. The SLA database 102 is accessible by the processor 120 through an interface, such as a computer bus.

The SLA GUI 110 is configured to receive input data from a user. The SLA GUI 110 may include one or more screen windows 111, 112, and 113 for entry of data. The SLA GUI 110 may include a screen window for display 114 of data, such as for validation, verification, or output of results. A customer may access and interface with the SLA GUI 110 through an input module 140, such as a keyboard, touch pad, stylus, mouse, touch screen, light pen, track ball, track pad, or voice input module, such as a voice recognition/text-to-speech module. The customer may also enter data into the SLA GUI 110 through a data file transmission, or other batch processing mode of operation. The SLA GUI 110 may comprise a web-based form, a SQL query form, a Cold Fusion interface, a spreadsheet, an interactive dialog script session, or other data entry application module.

The processor 120 is operable to determine, based on the SLA trigger, an SLA outcome based on the SLA term, the SLA desired outcome parameter, and the SLA comparator parameter. The processor 120 is further operable to store an SLA outcome record in the database based on the SLA outcome. The processor 120 may be configured to monitor the SLA term when an SLA encounter arises. SLA terms may be set to be evaluated at trigger points, such as a period-based trigger, or an event-based trigger. A period-based trigger includes daily, weekly, monthly, annual, bi-annual, quarterly, and other time-based triggers. An event-based trigger includes triggers based on a specific occurrence, such as a customer complaint, error in an application module, equipment failure, code errors and failures, service interruption, utility failure, or other non-periodic event. The processor 120 monitors and flags the SLA trigger point at occurrence, which is termed an SLA encounter. The processor 120 notifies the SLA owner, typically a client business entity, that an SLA trigger point has occurred. The processor 120 applies the SLA comparator term to the SLA term and the SLA desired outcome parameter to determine if the SLA is met or missed based on the SLA encounter. The processor 120 is operable to store an SLA outcome record in the SLA database 102 indicating whether the SLA is met or missed. The processor 120 transmits a notification to the client business entity with the SLA outcome record, and may send the SLA outcome record to a supplier business entity as well.

The storage 130 is coupled to the processor 120, and is configured to store data needed by the processor 120 for operation. The storage 130 may store operating system and application module code means, temporary files and application libraries accessed by the processor 120, textual data and graphic data files or code elements configured for use by the SLA GUI 110, and other data. The storage 130 may buffer data used by the processor 120 during operation, or may serve as a buffer to a communications interface. The storage 130 may comprise a flash memory, dynamic random access memory (DRAM), static random access memory (SRAM), electronically eraseable programmable read only memory (EEPROM), floppy disks, compact disc (CD), digital versatile disc (DVD), hard drive, Syquest, or Jazz drive.

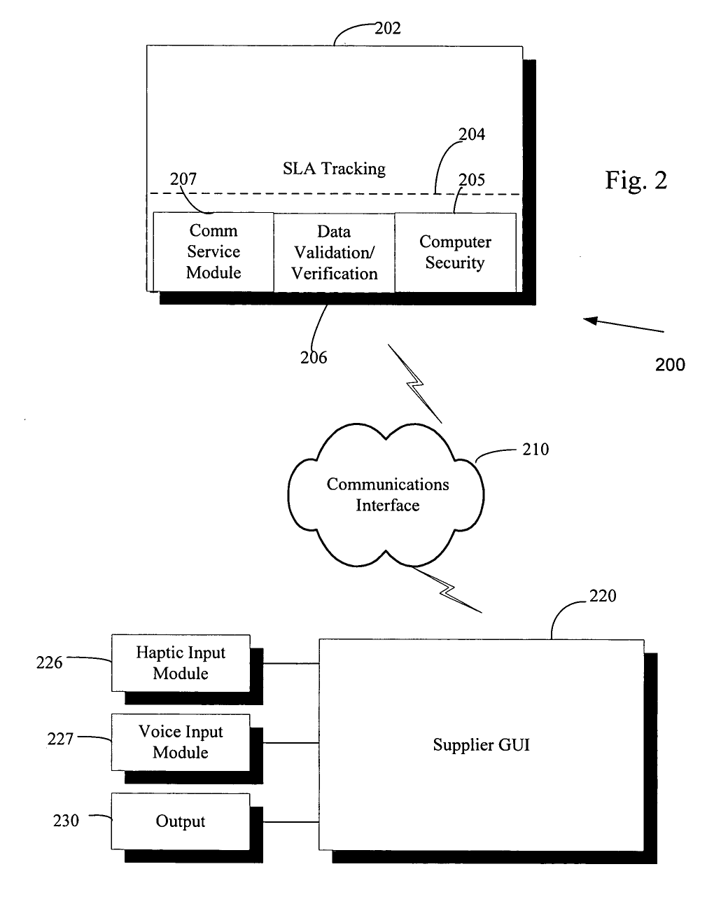

FIG. 2 illustrates an example supplier interface system 200 that interacts with an SLA tracking system. The supplier interface system 200 includes an SLA tracking system, such as described in FIG. 1, a supplier graphical user interface (GUI) 220, and a communications interface 210 coupling the SLA tracking system 202 and the supplier GUI 220. In addition, the SLA tracking system 202 includes a supplier interface module 204. The supplier interface module 204 is operable to accept customer input from the supplier GUI 220, transmit the supplier input to the processor 120, and transmit SLA outcome records and other data to the supplier GUI 520. The supplier interface module 504 may include computer security modules 205, that prevents unauthorized access to the SLA tracking system 100, data validation and data verification modules 206, communications service modules 207 that monitor communications performance and integrity with the communications interface 210.

The communications interface 210 may be a wired interface, such as a telephone dial-up, cable, DSL, or Ethernet communication network. The communications interface 210 may be a wireless interface, such as a WiFi, cellular telephone, or Bluetooth interface.

The supplier GUI 220 is coupled to the communications interface 210 and includes interface modules that allow a supplier to enter input data, such as SLA terms, SLA trigger points, SLA desired outcome parameters, and SLA desired outcome comparators. The supplier GUI 220 includes display modules that display information input by the customer, or information transmitted from the SLA tracking system 100, such as SLA outcome records, client comments, and SLA reports. The supplier GUI 220 includes graphical input and output elements, such as display windows, interactive dialog and query forms, or data verification display windows. In some embodiments, the supplier GUI 220 is coupled to an input module 225. The input module 225 includes tactile or haptic input 226, such as keyboards, keypads, touch screens, touch pads, light pens, touch styli, joysticks, a mouse, a tablet input, or remote key input. The input module 225 may, in some embodiments, include a voice input module 227, such as a VR/TTS system and microphone inputs. The supplier GUI 220 includes an output module 230, such as a display screen, printer, plotter, and/or audio output.

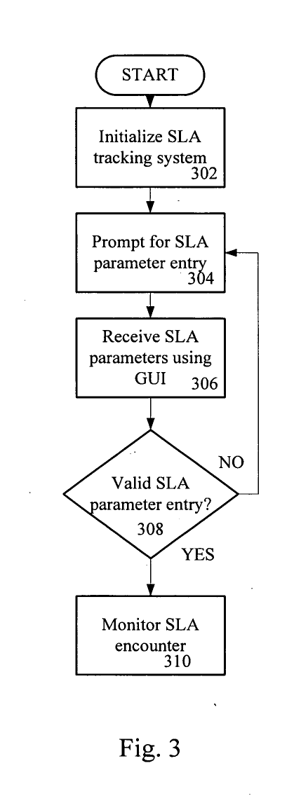

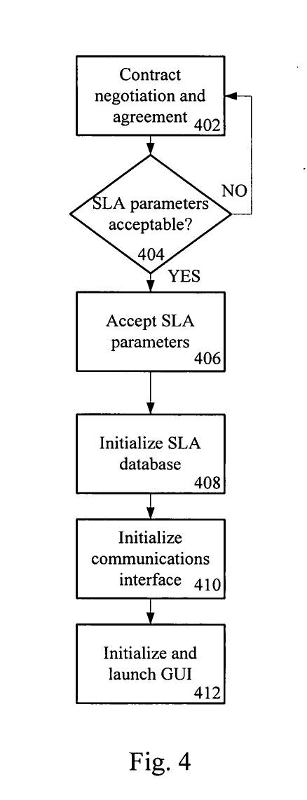

FIG. 3 illustrates an example process for entering SLA data into an SLA tracking application module. The SLA tracking system 100 is initialized, at block 302. FIG. 4 illustrates example steps that the SLA tracking system 100 follows to initialize. As a preliminary step, a contract negotiation and agreement generates a number of SLA parameters, at block 402. The SLA parameters may be evaluated, at step 404, to determine if the SLA parameters are acceptable, such as for formatting of the SLA parameters (for example, whether the SLA parameters represent quantitative parameters), whether the SLA parameters have a corresponding monitoring basis and associated comparison operator, and other evaluation measures. If the SLA parameters are determined to be unacceptable, then the process returns to block 402 to generate an acceptable set of SLA parameters.

If the SLA parameters are determined to be acceptable, then the SLA parameters are accepted by the business entities associated with the contract, at block 406. The SLA database 102 is initialized, at block 408. The SLA database 102 may be pre-processed, such as by deleting inconsistent or unnecessary data files, cacheing frequently used parameters, or creating file space, pointers, and data records configured for storage and retrieval of SLA parameters. The communications interface 210 is initialized to accept communication between the SLA tracking system 100 and the customer GUI 220. Communication channels may be opened and initiated, communications protocols may be loaded, and channel integrity may be verified at this block.

The SLA GUI 110 is initialized and launched, at block 412. The SLA tracking system 100 may load configuration files, graphical format and output files, and allocate processor capacity to interface with the SLA GUI 110.

In FIG. 3, the SLA tracking system 100 then prompts a user, such as a supplier business entity, to enter SLA parameters, at block 304. The SLA tracking system 100 provides a GUI 110 for the user. The GUI 110 allows entry of SLA terms, SLA trigger points, SLA desired encounter outcomes, and SLA outcome comparator data. The input data is received by the GUI 110, at block 306, and the input data is stored in the SLA database 102. The processor 110 may pre-process or format the data to match an SLA database format, or the input data may be buffered in the storage 130 before storing in the SLA database 102.

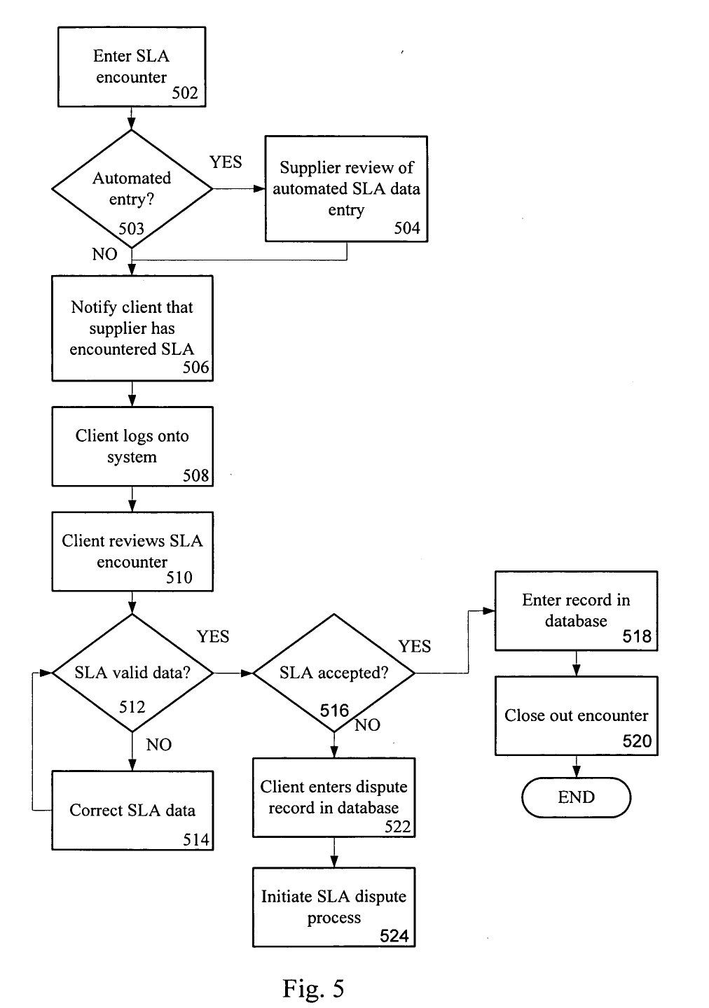

The SLA tracking system 100 determines if the input data is valid, at block 308. Data validation includes checking for a required data field, or that the entered input data matches an expected format or data type. The SLA tracking system 100 determines if the input data is correctly associated with a contract number or type, for example. If it is determined that the input data is not valid, the SLA tracking system 100 prompts for valid data entry by returning to block 304. If the input data is determined to be valid, the SLA tracking system 100 monitors the SLA at an SLA encounter, at block 310. The SLA tracking system 100 then performs the acts illustrated in FIG. 5

FIG. 5 illustrates example acts taken to monitor and track an SLA encounter. Data related to an SLA encounter is entered into the SLA tracking system 100, at block 502. The data may be entered manually, by the supplier business entity, or may be entered automatically by a program module coupled with the SLA tracking system 100. The SLA tracking system determines, at block 503, if the SLA encounter data is entered automatically. If the SLA encounter data is entered automatically, the SLA tracking system 100 notifies the supplier business entity, at block 504, and the supplier business entity is given an opportunity to review the SLA encounter data for consistency, accuracy, and format, for example.

The SLA tracking system 100 is configured to determine when a time-based or event-based trigger has occurred, at which time the SLA term is evaluated at the SLA encounter. The SLA tracking system 100 applies the SLA comparator, such as a greater than, less than, greater than or equal to, greater than or less than, and equal to operator, to the SLA term and an SLA desired outcome parameter.

The SLA tracking system 100 determines if the SLA outcome is valid, based on the SLA term, the SLA desired encounter outcome parameter, and the SLA comparator. For example, if the outcome of the SLA encounter is an erroneous value, or the outcome is not a numerical format, or other desired format, the SLA tracking system 100 may return an error message. If it is determined that the SLA outcome data is invalid, the SLA outcome data may be corrected or re-evaluated.

If the SLA outcome data is determined to be valid, the SLA tracking system 100 determines if the SLA term has been met. The SLA tracking system 100, applying the SLA encounter outcome, determines if the SLA encounter outcome is associated with a desired SLA encounter outcome. For example, an SLA term requiring a minimum number of lines of code per month for a software development project would be considered met if the SLA encounter showed that the number of lines of code produced and delivered at the SLA trigger was greater than the minimum number. Another example might include monitoring a response time to a customer complaint. If the SLA term requires a less than 10 minute response time to a reported customer complaint, based on an event trigger, the SLA term would be met if the monitored SLA encounter outcome showed a 5 minute response time to the customer complaint. Conversely, in this last example, if the response time to the customer complaint was 12 minutes, for example, the SLA term would be recorded as missed.

If the SLA term is determined to be met, the SLA term is recorded as met for the associated SLA encounter. The SLA tracking system 100 stores the SLA encounter outcome as a met result in an SLA outcome data record. The data record is stored in the SLA database 102.

The supplier business entity may override the “Met” and “Missed” determination made by the system with a “not applicable” (“N/A”) result. This may be necessary for situations where the client, in advance or otherwise, authorized a service level that was less than that required contractually. For example, an SLA may require the supplier to maintain an application at 99% up time. If on one particular day, the client authorizes the application to be taken down for a full day, and therefore having less than 99% up time for that day was acceptable even though it would appear that the SLA had been “missed” for the day.

If the SLA term is determined to be missed the SLA term is recorded as missed for the associated SLA encounter, at block 322. Based on the SLA encounter outcome, the SLA tracking system 100 stores the SLA outcome in the SLA database 102 as a missed result in an SLA encounter outcome data record. If the SLA encounter outcome is recorded as a missed results, the SLA tracking system 100 may trigger a liquidated damages recovery process if a liquidated damages amount is associated with the missed SLA. The SLA tracking system 100 may determine a liquidated damages amount associated with the missed SLA term, notify the client business entity of the liquidated damages amount, and may initiate a procedure to contact the supplier business entity to collect or assess the liquidated damages amount.

The SLA tracking system 100 notifies the client that the supplier has encountered an SLA and has entered data related to the SLA encounter, at block 506. The client business entity logs onto the system 100 to review the SLA encounter data, at block 508. The client business entity reviews the SLA encounter data, at block 510. The client business entity determines, at block 512, if the SLA encounter data is valid, such as whether the SLA was determined at the correct encounter frequency or event, or whether encounter data was correctly entered with proper format or comparator information. If the SLA encounter data is invalid, the SLA tracking system 100 may prompt the client business entity or the supplier business entity to enter valid SLA data, at block 514.

If the SLA data is determined to be valid, the system 100 communicates to the client business entity that an SLA encounter has occurred and that there is SLA encounter outcome data to review. The SLA tracking system 100 determines if the client business entity accepts the SLA encounter data, at block 516. If the client business entity does not accept the SLA encounter outcome, the SLA tracking system 100 allows the client business entity to record a comment, such as an SLA encounter outcome record, associated with the SLA term. The client business entity communicates the SLA encounter outcome record when the SLA encounter outcome record indicates that the client disputes the SLA encounter. The comment may include a request for more information from the supplier business entity concerning a missed or met SLA, may include requests for suggested changes to meet the SLA term, or may include change proposals to adjust the supplier business process to meet the SLA term. The SLA encounter outcome record indicating a disputed SLA encounter, along with included comments, is transmitted to the supplier business entity through the communications interface 210. The SLA record alternatively may be communicated orally to the supplier business entity by the client business entity.

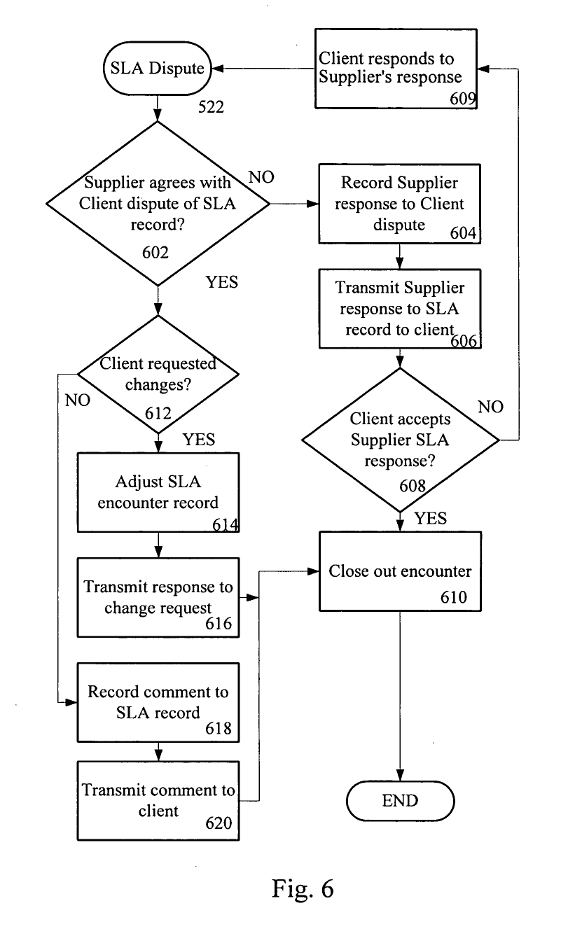

If the client business entity accepts the SLA encounter data, the system 100 stores a record in the SLA database 102, at block 518, and closes out the SLA encounter, at block 520. The process may then iterate at each SLA encounter trigger, depending on the frequency or trigger event associated with the SLA. If the client business entity disputes the SLA encounter data as entered by the supplier business entity, client business entity enters a dispute record in the SLA database 102 at block 522, and the SLA tracking system 100 initiates an SLA dispute process, at block 524, which is illustrated in further detail in FIG. 6.

FIG. 6 illustrates example acts that process a dispute resolution for a disputed SLA term. The method begins at block 522, where the supplier business entity receives notice that the client business entity disputes the SLA encounter data. It is determined, at block 602, if the supplier business entity agrees with the client business entity dispute of the SLA encounter outcome record. For example, the supplier business entity may be aware of the disputed SLA at the SLA encounter and agrees with the comments entered in the SLA comment record at block 522. Alternatively, the supplier business entity may disagree with the SLA comment record. If the supplier business entity agrees with the SLA comment record, it is next determined if the client business entity requested changes to the supplier-entered SLA encounter record associated with the SLA term, at block 612. If the client business entity requests changes to the supplier-entered SLA encounter record associated with the SLA term, the supplier business entity adjusts the associated SLA encounter record, at block 614, and transmits a corresponding response, at block 616, to the client business entity. In addition, the client business entity may request changes to the supplier business process in the SLA comment record. The supplier business entity may adjust internal performance measures, adjust quality standards, train or retrain personnel, acquire resources needed to respond to the SLA-related business process changes, or other steps to satisfy the process changes requested by the client business entity. The supplier business entity may record the changes made in the SLA outcome record received at block 522, transmit an acknowledgement to the client business entity, or may transmit a new SLA comment record to the client business entity, at block 616. The system then closes out the SLA encounter, at block 610.

If it is determined that the client business entity does not request changes to the supplier business process associated with the SLA term, then the supplier business entity may record a comment, at block 618 in the SLA outcome record, and may store the SLA encounter outcome record at a supplier business entity storage. The supplier business entity may transmit a comment record to the client business entity, at block 620. The system then closes out the SLA encounter, at block 610.

If the supplier business entity does not agree with the SLA encounter outcome record, at block 602, the supplier business entity records a supplier business entity response to the SLA outcome record, at block 604. The supplier business entity may dispute the comments provided in the SLA encounter outcome record. The supplier business entity may record an alternative set of comments to the SLA encounter outcome record, or may provide additional data associated with the SLA encounter. The supplier business entity transmits a supplier response to the SLA outcome record to the client business entity, at block 606. In one embodiment, the supplier business entity transmits the response through the communications interface 210. In another embodiment, the client business entity accesses the SLA GUI 110 and enters the response in a record stored in the SLA database 102.

After the client business entity receives the client business entity response, or is made aware of the client response, the SLA tracking system 100 determines if the client business entity accepts the supplier's SLA dispute response, at block 608. If the client business entity accepts the supplier business entity response, then the SLA encounter is closed out, at block 610. If the client business entity does not accept the supplier business entity response, the client business entity responds to the supplier business entity's response, at block 609. The SLA dispute process is repeated at block 522, where the client business entity may enter comments in the SLA database 102 related to the SLA encounter, and initiate the dispute process at block 524.

The client business entity may refer the disputed SLA to a review board or review process to determine the resolution of the dispute. The outcome of the dispute resolution may involve a renegotiation of the underlying contract SLA's, changes to the SLA's, changes in the supplier business processes associated with the SLA, or selection of an alternative supplier business entity associated with the disputed SLA's.

The automation of the SLA data entry, monitoring and tracking, and resolution of SLA encounters allows an efficient SLA process. A client business entity may quantitatively track, review, resolve, rank, and prioritize SLA's within an organization. The client may better understand underperforming suppliers, and conversely, may understand which suppliers may be efficient in supplying services other than the supplier's currently supplied services. For example, a software coding supplier may be determined to be efficient at providing human resources data entry and management, which the client may then award to the software coding supplier.

The SLA tracking system may be applicable to different business processes. Telecommunications information technology services, office automation, backend processing, and support are some examples of business services that the SLA tracking system may be configured to track. Other examples include personnel staffing and supply services, waste management and janitorial services, financial services, consulting, banking, legal, and management services. The use of the SLA tracking system is not limited to the described business models, however. The SLA tracking system may be configured for use in any service, manufacturing, software, or production process that requires the use of SLA's to determine performance metrics.

The SLA tracking system allows a quantitative comparison of SLA's across an organization, along with a process for responding to disputed SLA encounters. The SLA tracking system may be configured to feed an issue management system/issue management group if a given project has an unsatisfactory number of disputes in a given time period, has been disputing the same SLA encounter for an unsatisfactory period of time, or other problems that could require mediation by a third party.

The SLA tracking system may also be configured for non-SLA parameters and performance metrics as well. A user may configure the SLA tracking system to measure a set of data related to a non-SLA metric to determine a baseline of data, gather statistical information about a process, or determine quantitative metrics that may be suitable for definition and negotiation as SLA parameters prior to a contract formation.

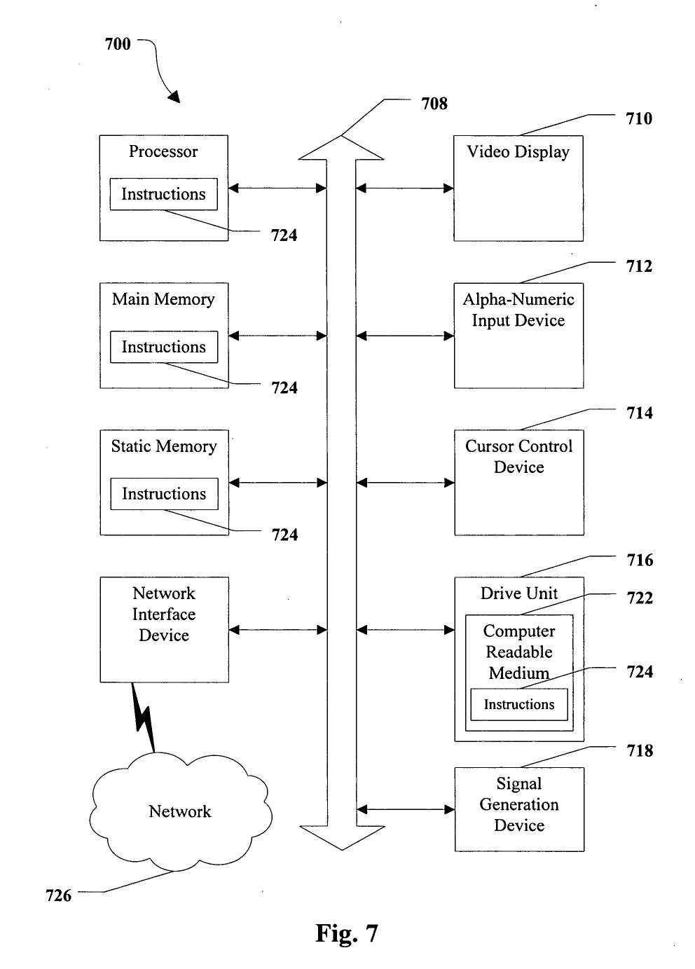

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method that monitors service level agreements (SLA) comprising:
entering one or more SLA parameters into a database using a graphical user interface adapted to accept the one or more SLA parameters, where the one or more SLA parameters include a service level agreement term, an SLA trigger associated with the SLA term, an SLA desired outcome parameter, and an SLA comparator parameter;
determining an SLA encounter outcome based on the SLA trigger, the SLA term, the SLA desired outcome parameter, and the SLA comparator parameter;
storing an SLA encounter outcome record in the database based on the SLA encounter outcome;
communicating the SLA encounter outcome record to a supplier business entity from a client business entity when the SLA outcome record indicates a disputed SLA encounter; and
responding to the SLA outcome record by the supplier business entity.

2. The method of claim 1 where entering the SLA trigger comprises entering at least one of a periodic frequency or an event-driven trigger.

3. The method of claim 1 where determining the SLA outcome comprises: comparing the SLA outcome with the desired SLA outcome parameter using the SLA comparator parameter; determining if the SLA term is missed when the SLA outcome does not correspond to the desired SLA outcome parameter using the SLA comparator parameter; and determining if the SLA term is met when the SLA outcome corresponds to the desired SLA outcome parameter using the SLA comparator parameter.

4. The method of claim 3 where storing the SLA outcome record comprises storing a comment record indicating that the SLA term is missed or met.

5. The method of claim 4 where responding to the SLA outcome record comprises at least one of: providing a response comment record by the supplier business entity to the client business entity, disputing the SLA outcome record, or providing an SLA change record.

6. The method of claim 5 where providing the SLA change record comprises adjusting a supplier business process to meet the SLA term.

7. The method of claim 1 further comprising validating the SLA outcome by the supplier business entity.

8. The method of claim 1 where entering the one or more service level agreement parameters comprises entering numerically valued SLA parameters.

9. The method of claim 1 further comprising: ranking the SLA outcome on a numerical scale, and setting a priority for the SLA outcome based on the ranking of the SLA outcome.

10. The method of claim 7 further comprising completing the SLA encounter record when the supplier business entity accepts the SLA outcome record after communicating the disputed SLA encounter outcome record.

11. The method of claim 11 further comprising:
disputing the SLA encounter outcome record by the supplier business entity when the supplier business entity does not accept the SLA outcome record;
transmitting an SLA dispute record to the client business entity; and
responding, by the client business entity, to the SLA dispute record.

12. A method that monitors service level agreements (SLA's) for information systems contracts comprising:
entering one or more SLA parameters by a supplier business entity into a database using a graphical user interfuse adapted to accept the one or more SLA parameters, where the one or more SLA parameters include an SLA, an SLA trigger associated with the SLA term, an SLA desired outcome parameter, and an SLA comparator parameter;
determining, at an SLA encounter event indicated by the SLA trigger, an SLA encounter outcome record, based on the SLA term, the SLA desired outcome parameter, and the SLA comparator parameter;
evaluating the SLA encounter event by the client business entity;
communicating an SLA encounter outcome record from a client business entity to a supplier business entity when the SLA outcome record indicates a disputed SLA encounter outcome;
initiating an SLA encounter outcome dispute process when the SLA outcome record indicates the disputed SLA encounter outcome; and
responding to the SLA encounter outcome record by the supplier business entity.

13. The method of claim 12 where the SLA trigger comprises at least one of a periodic frequency or an event-driven trigger.

14. The method of claim 10 where communicating the SLA encounter outcome record comprises communicating a requested supplier business process adjustment to meet the SLA term.

15. The method of claim 10 where responding to the SLA encounter outcome record comprises at least one of:
accepting the SLA encounter outcome record that indicates the dispute SLA encounter outcome;
rejecting the SLA encounter outcome record that indicates the dispute SLA encounter outcome; and
transmitting an SLA dispute comment record to the client business entity.

16. An apparatus for monitoring service level agreements (SLA's) comprising:
a database including data fields related to one or more SLA parameters, where the database is stored in a memory and where the one or more SLA parameters include an SLA term, an SLA trigger associated with the SLA term, an SLA desired encounter outcome parameter, and an SLA comparator parameter;
a graphical user interface adapted to accept the one or more service level agreement parameters into the database;
a processor operable to determine, based on the SLA trigger, an SLA encounter outcome based on the SLA term, the SLA encounter desired outcome parameter, and the SLA comparator parameter; and store an SLA encounter outcome record in the database based on the SLA outcome; and
a communications interface operable to communicate the SLA encounter outcome record from a supplier business entity to a client business entity when the SLA encounter outcome record indicates a disputed SLA encounter and operable to communicate a response to the SLA encounter outcome record by the client business entity.

17. The apparatus of claim 14 where the SLA trigger comprises at least one of a periodic frequency or an event-driven trigger.

18. The apparatus of claim 14 where the processor is further operable to compare the SLA encounter outcome with the desired SLA encounter outcome parameter using the SLA comparator parameter; determine if the SLA term is missed when the SLA encounter outcome does not correspond to the desired SLA encounter outcome parameter using the SLA comparator parameter; and determine if the SLA term is met when the SLA encounter outcome corresponds to the desired SLA encounter outcome parameter using the SLA comparator parameter.

19. The apparatus of claim 16 where the memory is further operable to store a comment record indicating that the SLA term is disputed.

20. The apparatus of claim 14 where the one or more service level agreement parameters comprise numerically valued SLA parameters.

21. The apparatus of claim 14 where the processor is further operable to rank the SLA encounter outcome on a numerical scale, and set a priority for the SLA outcome based on the ranking of the SLA outcome.

22. A computer program product comprising:
a computer useable medium having computer readable code for tracking service level agreements (SLA's) embodied in the medium, the computer readable code comprising:
computer readable code executable to store one or more SLA parameters into a database, where the one or more SLA parameters include an SLA term, an SLA trigger associated with the SLA term, an SLA desired encounter outcome parameter, and an SLA comparator parameter;
computer readable code executable to determine, based on the SLA trigger, an SLA encounter outcome based on the SLA term, the SLA desired encounter outcome parameter, and the SLA comparator parameter;
computer readable code executable to store an SLA encounter outcome record in the database based on the SLA outcome;
computer readable code executable to communicate the SLA encounter outcome record from a client business entity to a supplier business entity when the SLA outcome record indicates a disputed SLA encounter; and
computer readable code executable to process a response to the SLA outcome record by the supplier business entity.

23. The method of claim 1 further comprising:
determining liquidated damages data associated with a missed SLA term; and
initiating a liquidated damages recovery process when the missed SLA term occurs.
